(19) United States
(12) Patent Application Publication
(10) Pub. No.: US 2021/0001737 A1
(43) Pub. Date: Jan. 7, 2021

(54) Plug-In System for Charging an Electrical Energy Store

(71) Applicant: Bayerische Motoren Werke Aktiengesellschaft, Muenchen (DE)

(72) Inventors: Bernhard HOESS, Muenchen (DE); Robert HUBER, Landshut (DE)

(21) Appl. No.: 16/977,314

(22) PCT Filed: Feb. 11, 2019
(86) PCT No.: PCT/EP2019/053307

§ 371 Date: Sep. 1, 2020

(30) Foreign Application Priority Data
Mar. 2, 2018 (DE) 10 2018 203 162.2

(51) Int. Cl. B60L 53/16; H02J 7/00; H01R 13/453; H01R 13/52

(52) U.S. Cl. CPC B60L 53/16; H02J 7/0045; B60K 6/28; H01R 13/5213; H01R 2201/26; H01R 13/453

(57) ABSTRACT

A plug-in system for a wired charging process for charging an electrical energy store of an at least partially electrically operated device includes a charging socket positioned on the electrically operated device. The plug-in system has a charging device with a charging plug which can be extended towards the charging socket using a translational movement. The charging socket has a cover for protecting contact parts of the charging socket from environmental influences. The charging plug is designed to produce, as a result of the translational movement, one or more reclosable contact part openings in the cover, through which openings contact parts of the charging plug can be guided during the translational movement in order to form pairs of galvanically conductive connections to the corresponding contact parts of the charging socket.

### BACKGROUND AND SUMMARY OF THE INVENTION

The invention relates to a charging device for charging the electrical store of a vehicle.

Vehicles with an electric drive have a battery (i.e. an electrical energy store) in which electrical energy for operating an electric machine of the vehicle can be stored. The battery of the vehicle can be charged with electrical energy from a power supply grid. For this purpose, the battery is coupled to the power supply grid in order to transmit the electrical energy from the power supply grid into the battery of the vehicle. The coupling can be effected in a wired fashion (by means of a charging cable) and/or in a wireless fashion (using inductive coupling between a charging station and the vehicle).

In the case of a wire-bound charging process, the user of a vehicle plugs the plug of a charging cable into the charging socket of the vehicle. This manual activity can be unpleasant for the user (e.g. because the user can become dirty in the process). The plugging in of the charging cable can therefore be carried out automatically by means of a robot arm. However, providing a robot arm entails a relatively high degree of expenditure and relatively high costs. In particular, the expenditure on the automatic manufacture of a galvanic plug-in connection can be relatively high.

The present document is concerned with the technical problem of providing an efficient and reliable plug-in system which permits an automatic wired charging process. In particular, the intention here is to permit the efficient manufacture of a plug-in connection.

The problem is solved by the independent claims. Advantageous embodiments are described inter alia in the dependent claims. It is to be noted that additional features of a patent claim which is dependent on an independent patent claim can form, without the features of the independent patent claim or only in combination with a subset of the features of the independent patent claim, a separate invention which is independent of the combination of all the features of the independent patent claim and can be made the subject matter of an independent claim, of a divisional application or of a subsequent application. This applies in the same way to the technical teachings which are described in the description and which can form an invention which is independent of the features of the independent patent claims.

According to one aspect, a plug-in system for a wired charging process for charging an electrical energy store of an at least partially electrically operated device is disclosed. The at least partially electrically operated device can be a motor vehicle, in particular a road vehicle. The plug-in system can be designed to couple the electrical energy store galvanically to an electrical power supply (e.g. a charging pillar). In this context, the plug-in system can be designed to transmit charging power levels of 1 kW, 10 kW, 20 kW or more. Exemplary voltages are 300 V or more. The plug-in connection is preferably produced automatically.

The plug-in system comprises a charging socket which is arranged on the electrically operated device. The charging socket can have two or more contact parts by means of which a galvanically conductive connection can be respectively produced, in order to transmit electrical energy for charging the energy store.

The plug-in system also comprises a charging device (also referred to as a charging robot in this document). The charging device can be connected to the electrical energy supply and can be configured to provide electrical energy for charging the energy store. The charging device comprises a charging plug which can be extended and/or led toward the charging socket by means of a translatory movement. In this context, the charging plug can be arranged on or in a (preferably mobile) housing of the charging device. The charging plug can therefore be extended from the housing in order to produce a plug-in connection to the charging socket. In this context, the charging plug typically has one or more contact parts which can respectively establish a galvanically conductive connection to the corresponding one or more contact parts of the charging socket. The charging device can comprise an electrically operated actuator (e.g. an electric motor) which is configured to bring about the translatory movement of the charging plug automatically.

The charging socket can have a cover in order to protect the contact parts of the charging socket from environmental influences. The cover can cover the contact parts of the charging socket when there is no plug-in connection to a charging plug. On the other hand, the cover can have one or more reclosable contact part openings or holes which can be opened in order to establish a plug-in connection to a charging plug.

The charging plug can be designed to generate or open the one or more reclosable contact part openings in the cover by means of the translatory movement, through which openings the contact parts of the charging plug can be led within the scope of the translatory movement, in order to form, with the corresponding contact parts of the charging socket, respective pairs of galvanically conductive connections. The opening of the one or more contact part openings can take place automatically here in reaction to the translatory movement of the charging plug.

Furthermore, the charging plug can be designed to reclose the one or more contact part openings by means of an inverse translatory movement away from the charging socket, in order to protect the contact parts of the charging socket from environmental influences. The opening and/or closing of the one or more contact part openings can take place passively here, i.e. without the use of an electrically driven actuator within the charging socket.

An efficient and reliable plug-in system for charging an electrical energy store is therefore described, said system permitting automatic plugging in and unplugging of a charging plug.

The charging plug can have a guide bolt. Furthermore, the cover can have a bolt opening for receiving the guide bolt. In this context, the bolt opening can have a shape and/or size which corresponds to the guide bolt, so that the guide bolt can be moved in a defined fashion into the cover.

The charging plug and cover can be embodied in such a way that the one or more contact part openings are formed in reaction to the fact that within the scope of the translatory movement the guide bolt is moved within the bolt opening (in particular is led into the bolt opening). The guide bolt can have a conical end which faces the cover of the charging socket. Through the use of a guide bolt it is possible to reliably produce a plug-in connection. In particular, by means of the guide bolt and the bolt openings it is possible to bring about a defined orientation between the charging plug and charging socket. Furthermore, the one or more contact part openings can be opened and closed again in an efficient and reliable way by means of a guide bolt.

The contact parts of the charging plug can be arranged on the charging plug in such a way that within the scope of the translatory movement the guide bolt firstly penetrates the bolt opening before the contact parts reach the cover. Such an arrangement can ensure that the one or more contact part openings are opened promptly just before the contact parts of the charging plug are reached and are reclosed promptly after the contact parts of the charging plug are pulled out. In this way, soiling of the charging socket can be reliably avoided.

The cover can have at least two cover disks, each with one or more holes. The cover disks can be rotatable with respect to one another so that the positions of the one or more holes in the first cover disk can be changed with respect to the positions of the one or more holes in the second cover disk. In particular in a closed state the holes of the cover disks can be arranged in such a way that they are not on top of one another so that the cover is closed. On the other hand, in an opened state the holes in the cover disks can be arranged one on top of the other at least in certain areas so that the cover is opened, in particular so that the one or more contact part openings are formed.

The guide bolt and the cover disks can be embodied in such a way that in reaction to the translatory movement of the guide bolt within the bolt opening the cover disks are rotated with respect to one another so that holes in the cover disks are aligned one on top of the other, and in this way they form the one or more contact part openings. Through the use of cover disks it is efficiently possible to make available reclosable contact part openings.

The rotation of the cover disks can be brought about by the guide bolt. In particular, the charging socket can be embodied in a passive fashion such that the charging socket does not have an electrically operated drive for rotating the cover disks. On the other hand, the guide bolt can have a slotted link which is designed to interact with a link block on at least one of the cover disks, in order to rotate the cover disks with respect to one another. In a correspondingly inverted case, the link block can be arranged on the guide bolt, and a slotted link can be arranged on at least one of the cover disks. Through the use of a slotted link it is possible to efficiently bring about a rotational movement of at least one cover disk by means of a translatory movement of the guide bolt.

At least one seal can be arranged between the two cover disks. In this way, the protection of the charging socket against soiling can be increased further.

The charging socket can have a pressure element (e.g. a compression spring) which is configured to apply a compressive force to the two cover disks in order to compress the cover disks. In this context, the charging socket can be embodied in such a way that the compressive force is reduced in reaction to the translatory movement of the guide bolt within the bolt opening. Through the provision of a pressure element it is possible to protect the charging socket reliably against soiling.

The guide bolt can be designed to form a galvanically conductive connection to a contact element of the charging socket. In other words, the guide bolt can be used, in addition to the contact parts of the charging plug, to form a galvanically conductive connection to the charging socket (e.g. in order to transmit data). In this way, the efficiency of the plug-in system can be increased further.

The charging plug and the charging socket can be embodied in such a way that the contact parts are locked to one another within the scope of the translatory movement. In this way, the reliability of the plug-in system can be increased further.

A contact part of the charging plug and a corresponding contact part of the charging socket can have complementary profiles. A securing force can be produced by the complementary profiles when the contact parts are plugged one into the other. Alternatively or additionally, a contact surface between the contact parts which is enlarged in comparison with a planar profile can be made available by the complementary profiles. In this way, the reliability of a plug-in connection can be increased further.

As already explained above, the charging device can have a mobile housing on or in which the charging plug is arranged. Furthermore, the charging device can have a winding roller which is configured to wind on a charging cable by means of which the charging plug is or can be connected to a power supply or to an electrical energy supply. In this context, the winding roller can preferably be embodied, in the event of a movement of the charging device, to unwind or wind on the charging cable in such a way that the charging cable is (always) tensioned between the power supply and the charging device. The winding roller can be arranged on an outer wall of the housing so as to be rotatable about a vertical axis of the charging device. Providing a winding roller makes it possible to reliably move and, if appropriate, orientate the charging device.

As already explained above, the at least partially electrically operated device can be a road vehicle. The charging socket can be arranged on an underfloor of the road vehicle. The charging device can be designed to plug the charging plug into the charging socket along a vertically extending translatory movement. In this way a plug-in connection for charging the drive store of an at least partially electrically driven vehicle can be produced in a particularly reliable way.

According to a further aspect, a charging device and/or a charging socket are described for the plug-in system which is described in this document.

In particular, a charging socket for a plug-in system is described, wherein the plug-in system permits a wired charging process for charging an electrical energy store of an at least partially electrically operated device. The charging socket is designed to be arranged on the electrically operated device. The plug-in system also comprises a charging device with a charging plug which can be extended toward the charging socket by means of an (if appropriate exclusively) translatory movement.

The charging socket comprises contact parts which are configured to transmit electrical energy for charging the electrical energy store. Furthermore, the charging socket comprises a cover in order to protect contact parts of the charging socket from environmental influences. The charging socket is designed to open, in reaction to the translatory movement of the charging device, one or more reclosable contact part openings in the cover, through which openings contact parts of the charging plug can be led within the scope of the translatory movement, in order to form, with the corresponding contact parts of the charging socket, respective pairs of galvanically conducive connections.

In this context, the one or more reclosable contact part openings preferably have a shape or profile which corresponds to a shape or profile of the contact parts of the charging plug. In other words, the shape and/or size of the contact part openings can be adapted or matched to the shape or size of the contact parts of the charging plug. In particular, a suitable contact part opening can be formed for each contact part of the charging plug. At other locations, the cover can continue to cover the charging socket so that even when there is an existing plug-in connection there continues to be reliable protection from environmental influences. The contact part openings can be such that the contact part openings are essentially sealed by the corresponding contact parts of the charging plug.

Furthermore, in this document a charging device for a plug-in system is described. The plug-in system permits here a wired charging process for charging an electrical energy store of an at least partially electrically operated device. The charging device comprises a charging plug which, by means of an (if appropriate purely) translatory movement, can be extended toward a charging socket which is arranged on the at least partially electrically operated device. In particular, the charging plug can be limited to carrying out a purely translatory movement (and e.g. no rotation). Furthermore, the charging socket comprises a cover in order to protect contact parts of the charging socket from environmental influences. The charging plug is designed to generate one or more reclosable contact part openings in the cover by means of the translatory movement, through which openings contact parts of the charging plug can be led within the scope of the translatory movement, in order to form, with the corresponding contact parts of the charging socket, respective pairs of galvanically conductive connections.

According to a further aspect, a road vehicle (in particular a passenger car or a truck or a bus) is described which comprises the charging socket which is described in this document.

According to a further aspect, a charging pillar is described which comprises the charging device which is described in this document.

It is to be noted that the methods, devices and systems which are described in this document can be used either alone or else in combination with other methods, devices and systems which are described in this document. Furthermore, any aspects of the methods, devices and systems which are described in this document can be combined with one another in a variety of ways. In particular, the features of the claims can be combined with one another in a variety of ways.

In the text which follows, the invention is described in more detail on the basis of exemplary embodiments.

### BRIEF DESCRIPTION OF THE DRAWINGS

FIGS. 1a and 1b show an exemplary charging device in a side view.

FIG. 1c shows an exemplary charging device in a plan view.

FIG. 1d shows an exemplary charging system for charging a vehicle.

FIG. 2a shows an exemplary winding roller for receiving a charging cable.

FIG. 2b shows an exemplary cable guide for a charging cable.

FIG. 3a shows an exemplary plug-in system for a wired charging system.

FIG. 3b shows different positions of a closure disk of a vehicle-end plug-in module.

FIG. 4 shows different embodiments of the plug-in system.

### DETAILED DESCRIPTION OF THE DRAWINGS

As stated at the beginning, the present document is concerned with the reliable and efficient execution of an automatic wired charging process. In particular, the present document is concerned here with the efficient production of a galvanically conductive plug-in connection between a charging cable and a cable socket of a vehicle.

One of the obstacles to the acceptance and spreading of electromobility is a relatively time-consuming and complicated charging process for charging the traction batteries of purely electric vehicles (BEV) and plug-in hybrid vehicles (PHEV). In principle it is possible to differentiate between conductive and inductive charging processes. Active involvement by the vehicle user is usually necessary in both types of charging process. In the case of a conductive charging process, the charging cable usually has to be plugged in manually. An inductive charging process requires precise positioning and orientation of the vehicle relative to a ground coil as well as the installation of the ground coil at the parking location of the vehicle. Inductive charging systems are currently still in the development phase. Therefore, a charging process is currently almost exclusively conductive. In this context, after the vehicle has been parked, the vehicle has to be connected to a power grid or to a charging pillar via a suitable charging cable with the plug-in system before the charging process. Likewise, after the charging process the charging cable has to be unplugged again and correspondingly stowed away.

For the acceptance of electrified vehicles it is advantageous to make the charging process as pleasant as possible for a user. In particular, it should be possible to carry out a charging process as autonomously as possible, with the least possible effort, and as far as possible in a space-saving and cost-effective way and without effects on or impairments of the vehicle, the user or the charging infrastructure. There is therefore a need for a system for automatically charging the traction battery of electrified vehicles.

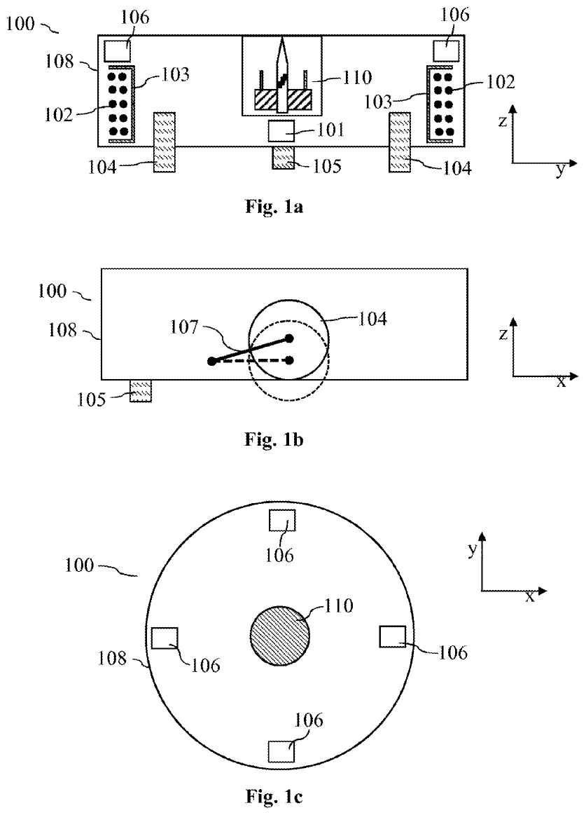

FIGS. 1a to 1d show a charging device 100 (in particular a charging robot) which permits automatic conductive charging in an efficient and reliable way. The charging device 100 can have a housing or a driving unit 108 with one or more driver wheels 104 and one or more supporting wheels or jockey wheels 105 which permit the charging device 100 to move over an underlying surface. In particular, in this context the charging device 100 can be moved under the underfloor of a vehicle 120 (as illustrated in FIG. 1d).

The charging device 100 is connected to an energy supply 140 via a charging cable 102. The charging cable 102 can be wound onto a winding roller 130. In this context, the winding roller 103 can be rotatable about the z axis or vertical axis. Electrical energy (e.g. an AC current and/or a DC current) can be transmitted from the energy supply 140 to a charging plug 110 (in this document also referred to as a plugging arm) of the charging device 100 via the charging cable 102. The charging plug 110 can be plugged automatically into a charging socket 130 of a vehicle 120 for a charging process, in order to charge an electrical energy store 123 of the vehicle 120 via a galvanically conductive connection. In particular, in this context the charging plug 110 can be moved out of the charging device 100 in the vertical direction (e.g. in the z direction of the vehicle 100), in order to plug the charging plug 110 into the charging socket 130 which is arranged on the underfloor of the vehicle 100 (see FIG. 1d). In this way, a (galvanically conductive) plug-in connection between the charging device 100 and the vehicle 120 can be produced in a reliable and efficient way.

The one or more drive wheels 104 of the charging device 100 can be moved out from a housing 108 of the charging device 100 or suspended therein by means of a movable arm 107, in order to permit a flexible movement of the charging device 100. On the other hand, the one or more drive wheels 104 can be retracted in the housing 108 of the charging device 100 in order to cause the charging device 100 to be fixedly located at a specific position (e.g. underneath the charging socket 130) (see FIG. 1b).

The charging device 100 can comprise one or more surroundings sensors 106 which are configured to acquire sensor data relating to a surrounding area of the charging device 100. Exemplary surrounding sensors 106 are: a distance sensor, a radar sensor, an ultrasound sensor, an image sensor, a camera, etc. In addition, the charging device 100 comprises a control unit 101 which is configured to control the charging device 100. In particular, the control unit 101 can be configured to control a movement of the charging device 100 in accordance with the sensor data of the one or more surroundings sensors 106. In this context, the charging device 100 can be positioned under the charging socket 130 of a vehicle 120 on the basis of the sensor data. Furthermore, the control unit 101 can cause the charging plug 110 to be moved out of the charging device 100, in order to establish a plug-in connection to the charging socket 130.

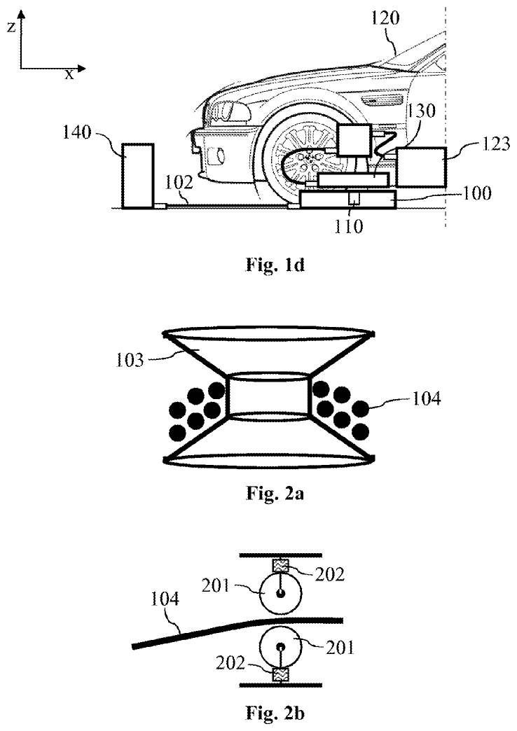

FIG. 2a shows an exemplary winding roller 103 onto which the charging cable 104 can be wound. In this context, the charging cable 104 can be pulled from the winding roller 103 by, e.g. a torque which acts on the winding roller 103, in order to cause the charging cable 104 to be repeatedly wound on and kept taut as the charging device 100 moves. In this context, the winding roller 103 preferably has a V-shaped profile in order to permit reliable winding on of the charging cable 104.

FIG. 2b shows exemplary cable guide with which the charging cable 104 can be led out of the housing 108 of the charging device 100 or into the housing 108 of the charging device 100. The cable guide can have driven rollers 201 between which the charging cable 104 is fed through. The rollers 201 can be pressed onto the charging cable 104 by means of springs 202. The charging cable 104 can be wound on or unwound by means of the driven rollers 201. Furthermore, the movement of the rollers 201 can be used to navigate the charging device 100.

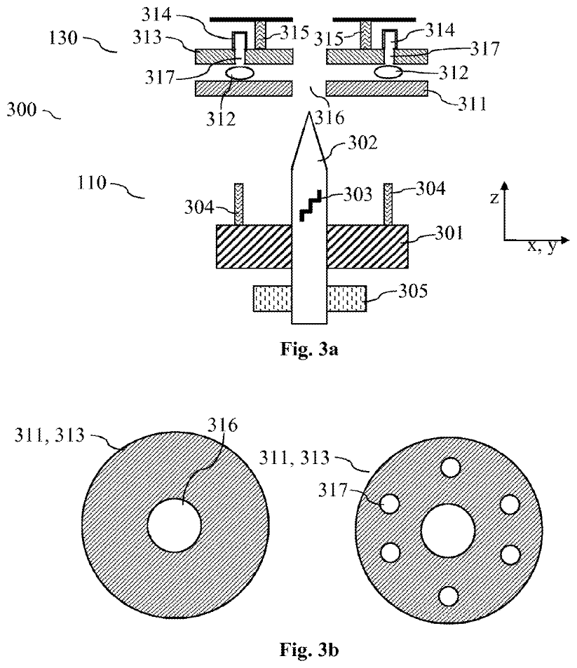

As already explained above, a charging plug 110 can be moved out of the charging device 100 and plugged into the charging socket 130 of a vehicle 120. FIG. 3a shows an exemplary charging plug 110 of a plug-in system 300, wherein the charging plug 110 can be moved out of the housing 108 of the charging device 100 or moved into the housing 108 by means of one or more actuators 305 (e.g. one or more electric motors). In particular, in this context a guide bolt 302 of the charging plug 110 can be moved in a vertical direction. A plug 301 with one or more electric contact parts 304 (e.g. pins) can be arranged on the guide bolt 302. An electrically and galvanically conductive connection with corresponding contact parts 314 (e.g. contact holes) of the charging socket 130 can be respectively established by means of the one or more contact parts 304.

The charging socket 130 can have a plurality of (cover) disks 311, 313 which can be used to close or open the one or more contact parts 314 of the charging socket 130. In particular, soiling of the contact parts 314 of the charging socket 130 can be avoided by means of the disks 311, 313. The disks 311, 313 can each have an opening 316 (e.g. a drilled hole) into which the guide bolt 302 of the charging plug 110 can be introduced. The charging plug 110, in particular the guide bolt 302, can be conical at the end facing the charging socket 130, so that the guide bolt 302 can be reliably plugged into the opening 316.

If the guide bolt 302 is plugged into the (bolt) opening 316, this brings about rotation of the two disks 311, 313 relative to one another. For this purpose, the guide bolt 302 can have e.g. a slotted link 303 which interacts with at least one of the disks 311, 313 and in the process brings about the relative rotation of the disks 311, 313. Owing to the relative rotation of the disks 311, 313, one or more holes 317 through the disks 311, 313 can be opened, through which holes 317 the corresponding one or more contact parts 304 of the charging plug 110 can be fed in order to make contact with the corresponding one or more contact parts 314 of the charging socket 130. On the other hand, when the guide bolt 302 is pulled out a relative rotation of the disks 311, 313 can be brought about, by means of which rotation the one or more holes 317 are closed again. FIG. 3b shows the disks 311, 313 in a closed state (left-hand side) and an opened state (right-hand side).

The charging socket 130 can comprise pressure means 315 (e.g. one or more springs) by which the two disks 311, 313 are compressed.

Furthermore, a seal 312 can be arranged between the disks 311, 313. In this way, reliable closing of the holes 317 and reliable protection of the contact parts 314 of the charging socket 130 from soiling can be made possible.

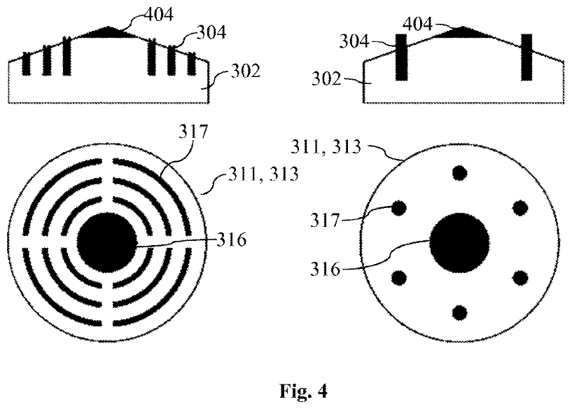

FIG. 4 shows different embodiments of the contact parts 304 of the charging plug 100 and of the charging socket 130. In the example illustrated on the left-hand side, the contact parts 304 have the shape of circular segments. In the example illustrated on the right-hand side, the contact parts 304 have a circular shape. The holes 317 in the disks 311, 312 (in this document also referred to as contact part openings) then have a respectively corresponding shape.

As illustrated in FIG. 4, the tip of the guide bolt 302 can be used as a contact part 404, e.g. in order to define a common mass between the charging device 100 and the charging socket 130 and/or in order to transmit data.

A charging robot 100 for an automatic charging process for BEVs and PHEVs with an emphasis on conductive power transmission is therefore described. Manual activities can therefore be dispensed with and can be replaced by an autonomous charging device 100 based on robotics. The described charging device 100 comprises a driving unit 108 (with one or more drive wheels 105), an extendible charging plug or plugging arm 110, a cable management system, actuator system 305, sensor system 106 (including means for detecting position, surroundings and an induction field) and a control unit 101. The described charging robot 100 can comprise all of the properties, individual properties or a combination of the properties described in this document.

The driving unit 108 bears the plugging arm 110 and the unit 103 for the cable management system. The driving unit 108 serves to move the charging robot 100 including the charging cable 102 and plug 110 toward a vehicle 120 and to position it for the plug-in process. Furthermore, the driving unit 108 serves to move the charging robot 100 out of the driving area of the vehicle 120 again after the charging process and, if appropriate, to move back to its initial position. The plugging arm 110 is preferably compactly folded up or retracted during travel.

The travel drive of the charging device 100 preferably comprises at least three wheels 104, 105, of which at least one wheel 104 is driven and at least one wheel 105 can be rotated. An exemplary embodiment is composed of two individually driven wheels 104 which form an axle, and a freely rotatable wheel 104 in front of or behind this axle (see FIG. 1a). The steering is carried out here by means of torque control and/or rotational speed control of the two driven wheels 104. Alternatively, the two driven wheels 104 can have a common drive, and the steering can be carried out by means of the third actively rotatable wheel 105.

A further exemplary embodiment has four wheels 104, 105 which are arranged in pairs on two axles, one of which is driven and the second of which serves for steering. Alternatively, the steering can be embodied as articulated steering. All or else some of the wheels 104, 105, preferably the wheels on the driven axle or the axle itself, can be spring-mounted in order to be able to travel over obstacles even when there is little static ground clearance. A mobile and/or sprung steering system of a wheel 104 is illustrated in FIG. 1b.

In order to avoid stumbling blocks and in order to avoid the risk of tangling of the charging cable 102 with the charging robot 100, the charging cable 102 is preferably laid over the shortest possible direct route to the charging socket 130 of a vehicle 120 and removed again after the charging process. This is done by means of a unit for cable management, which always make available precisely so much free charging cable 102 that the driving unit 108 can maneuver in an unimpeded way. The free cable length can be controlled actively (e.g. by means of a servomotor) or passively (e.g. by means of a spring system). Furthermore, the length of the free charging cable 102 can be determined (e.g. for navigation purposes).

The cable management unit can be embodied as a round winding roller 103. In this context, the winding roller 103 can be arranged at the outermost circumference of the charging robot 100 (as illustrated in FIG. 1a). This is e.g. a round winding roller 103 which is mounted so as to be rotatable (about the z axis) in the charging robot 100 and leads the charging cable 102 outward via a cable guide 201, 202 at a specific point on the charging robot 100.

FIG. 2a shows an example of a winding roller 103. A V-shaped or C-shaped contour of the winding roller 103 permits reliable routing of the charging cable 102. The winding roller 103 can carry out the rolling on of the charging cable 102 passively (by means of a spring system) (unrolling is carried out by driving the robot 100) or can carry out the rolling on and unrolling of the charging cable 102 actively (e.g. by means of an electromotor).

FIG. 2b shows an exemplary cable exit with an optional cable guide 201, 202. By means of correspondingly mounted rollers 201, it is possible to sense the unrolling direction of the charging cable 102. This information can be used e.g. to support the route planning or to detect a snagged charging cable 102 or to “release” a snagged charging cable 102. In order to permit the charging cable 102 to be wound on and unwound as easily as possible, the charging cable 102 is preferably wound on and unwound under slight tension.

The unit for the cable management can be used to navigate the charging robot 100 back into the initial position again after the charging process in that the charging robot 100 moves back along the charging cable 102 or pulls itself along the charging cable 102.

After the charging robot 100 has been positioned within a range of the charging socket 130 on the vehicle 120, the plugging in process is carried out by means of an extendible charging plug or plugging arm 110. The plugging arm 110 comprises a unit 305 for extending and moving a plug 301 of the plugging arm 110. The plugging arm 110 is preferably embodied in such a way that the plugging arm 110 plugs the plug 301 into the charging socket 130 with relatively simple kinematics. For this purpose, at least one (and if appropriate precisely one) actuated degree of freedom is used.

The plugging arm 110 preferably has the possibility of opening a seal of the plug 301 or of the charging socket 130 before the galvanic connection in conjunction with a suitable charging socket 130, and optionally bringing about locking of the plug 301 and charging socket 130 after the galvanic connection. The kinematics of the plug-in process can also be used for this process. Alternatively or additionally, an additional actuated degree of freedom can be used. In this way, a seal of the charging socket 130 on a vehicle 120 can be opened in an integrated movement of the plugging arm 110, and the actual plugging process (“galvanic connection”) can be carried out and/or a locking process can be carried out. This has the advantage that the active robotic elements are limited to the charging robot 100, and a purely passive charging socket 130 on a vehicle 120 can be used. Alternatively, the opening of the sealed charging socket 130 and/or the locking of the plug 301 and charging socket 130 can be carried out by means of an actuator system which is integrated into the charging socket 130.

The plugging arm 110 can have a suitable optional centering and aligning unit (e.g. in the form of conical guide bolt 302). In this case, the positioning of the plugging arm 110 can be carried out by means of the driving unit 108 only to the degree of accuracy with which an e.g. conical centering means engages. In this case, the plugging arm 110 preferably has degrees of freedom which permit the plugging arm 110 to align and center itself with respect to the charging socket 130 (if appropriate without displacement of the driving unit 108). This can be done e.g. by means of suitable mounting or elasticity of the plugging arm 110 in the driving unit 108 (e.g. elastic mounting, elastic plugging arm 110, linear leads perpendicular to the extension movement etc.).

An example of a charging robot 100 with a centrally arranged extendible plugging arm 110 is illustrated in FIGS. 1a to 1d. In this example, the driving unit 108 is positioned directly under the charging socket 130 which is mounted e.g. in the underfloor area of the vehicle 110. The plug-in process is initiated by extending the plugging arm 110 upward (“z direction”). An opening process of the charging socket 130 including the seal 312, and if appropriate locking and unlocking can be carried out by rotating the plugging arm 110 about the z axis (as illustrated in FIG. 3a). The rotation about the axis of the plugging arm 110 can be carried out actively using a suitable actuation means or passively using suitably combined kinematics (e.g. the translatory movement in the z direction can be converted into a rotational movement for the locking and/or opening process of the charging socket 130 by means of a suitable slotted link 303). In this context it is possible that the plugging arm 110 rotates about its axis. Alternatively or additionally, a translatory movement of the plugging arm 110 and a rotation of the counterpart of the charging socket 130 (in particular of a disk 311, 313) can take place. When a corresponding conical centering/alignment system is used, the precise positioning of the contact parts 304 of the plug 301 and of the contact parts 314 of the charging socket 130 only occurs directly before the galvanic connection is established. For this purpose, the plugging arm 110 can be movably mounted in the x-y plane and/or the plugging arm 110 can be designed to permit the necessary compensation by means of an elastic element.

FIG. 3a shows an exemplary plug concept with an optional centering/aligning unit. The plug concept permits reliable galvanic connection of a plug 301 (on the charging robot 100) and of a corresponding plug of the charging socket 130 (on a vehicle 120). Furthermore, a seal of the plug 301 and corresponding plug are protected against dirt and moisture (in particular for the charging socket 130 which is mounted on a vehicle 120).

A cover and/or seal on the charging robot 100 can be made available, for example, by means of a relatively simple flap mechanism which is pressed on e.g. by means of the extending plugging arm 110 or is actively opened by means of an actuator.

The charging socket 130 can have a suitable actuator system which opens a sealed flap or a bladed closure before the plug-in process. A passive unit, which is activated by the plugging arm 110, is preferably used on the charging socket 130. A centering and alignment process by means of a corresponding suitable unit preferably precedes the actual galvanic plugging in process, in order thereby to reduce the requirements which are made of the positioning of the driving unit 108. An example of such a centering unit is a conical guide bolt 302 which engages in a corresponding counterpart (in particular into a corresponding hole) 316 of the charging socket 130 even in the case of imprecise relative positioning of the charging robot 100 and charging socket 130. When the conical guide bolt 302 is introduced further into the counterpart 316 of the charging socket 130, the guide bolt 302 centers itself in the counterpart 316 and in this way aligns the contact parts 304 of the plug 301 and the corresponding contact parts 314 of the charging socket 130 suitably with one another.

An example of a combined plug-in system (sealing, plugging and locking) is illustrated in FIGS. 3a and 3b. The charging socket has not only the contact parts 314 of the corresponding plug but also a sealing unit 311, 312, 313 which can be opened by a rotation and also additionally at the same time can make available a locking function.

The sealing unit 311, 312, 313 can have two disks 311, 313 with off center cutouts 317 for the current-conducting contact parts 304 (in particular pins) of the plugging arm 110. Furthermore, seals 312 can be arranged between the disks 311, 313. Optionally, spring prestress 315 can be made available in order to apply pressure to the seals 312. The disks 311, 313 are mounted so as to be rotatable in relation to one another so that at least two different configurations, positions or states occur. In a first position, the cutouts 317 are staggered in the two disks 311, 313 so that the combination of the two disks 311, 313 constitutes a sealed unit. In a second position, the cutouts 317 of the disks 311, 313 are arranged directly over one another so that the current-conducting pins or sockets 304 of the plug 301 can be plugged through the cutouts 317 in the disks 311, 313 onto the corresponding pins or sockets 314 of the corresponding plug.

Both disks 311, 313 can have in the center a cutout 316 for receiving the (conical) guide bolt 302 (in particular for centering/alignment). A slotted link 303 can be arranged in the guide bolt 302, said slotted link 303 interacting with a corresponding counterpart on one or both of the disks 311, 313 so that the translatory movement of the guide bolt 302 along the disk axis brings about a relative rotational movement of the two disks 311, 313 with respect to one another. The opening of the seal 312 is carried out by rotating the disks 311, 313 in relation to one another, optionally in conjunction with a translatory force effect in order to reduce the optional prestressing force on the seals 312. The locking can also be carried out by means of the contour of the slotted link 303 in conjunction with one or more counterparts.

The contact parts 304 for the galvanic connection are preferably arranged in a rotationally symmetrical fashion around the guide bolt 302 for the centering process. Optionally, a further contact part 404 (e.g. for a data connection) can be arranged in the center at the end of the guide bolt 302.

A plug-in system with an integrated centering/alignment unit can have e.g. a cone with a stem as a centering and aligning unit. The plug-in system for galvanic connection is preferably arranged in a rotationally symmetrical fashion with respect to the cone here. Furthermore, a sealing system can be provided. FIG. 4 shows, on the left-hand side, a plug unit with contact faces or contact parts 304 which are arranged in an annular-concentric fashion. In this context, a plug-in system typically has at least two contact parts 304. Such a plug-in system is advantageously combined with a rotational movement during the plug-in process so that the contact points are moved with respect to one another. This brings about a reduction in the contact resistance. The upper end faces of the contact parts 304 optionally have a suitable contour which, in conjunction with the corresponding contour of the contact parts 314 of the corresponding plug, ensure secure and good contact, e.g. by enlarging the contact face and/or by making available a clamping function or centering function.

The charging device 100 can have an actuator system for the driving unit 108, the cable management system and/or the plugging arm 110. Depending on the design of the charging robot 100 and the installed optional components, exemplary actuators are: actuator system for wheel drive and steering system; actuator system for the winding roller 103; actuator system 305 for extending the charging plug 301; actuator system for rotating the charging plug 301; and/or actuator system for opening the cover flap of the charging plug 301.

The sensing of the surroundings of the charging robot 100 can be carried out by means of distance sensors (e.g. ultrasound, . . . ) and/or by means of a photosensor in conjunction with image recognition. In order to evaluate the photosensor, the tires of the vehicle 120 can serve as a characteristic detection feature for a vehicle 120 (round black objects). Furthermore, by means of a relatively simple light/dark comparison or contour comparison it is possible to detect whether the state of a parking place for a charging process (vehicle 120 present or not) has changed.

The one or more distance sensors 106 are preferably oriented parallel to the underlying surface. At least two distance sensors 106 can be used to measure the distance from the tires of the vehicle 120 when the charging robot 100 moves under a vehicle 120. With this information it is possible to determine the position of the charging robot 100 relative to the vehicle 120, to orientate an angle of the charging robot 100 relative to the vehicle 120 and to detect whether the charging robot 100 is located to the side of or in front of or behind the vehicle 120.

In order to detect the vehicle 120 from the distance, possibly one or more of the sensors 106 can be inclined slightly upward (e.g. at max 45°). At least one additional distance sensor 106 is optionally oriented perpendicularly with respect to the underlying surface. In this way, when the charging robot 100 moves in under a vehicle 120, a height profile of the vehicle underfloor can be sensed, which profile can be used to identify the vehicle 120 (in particular a vehicle type) and/or to determine the orientation/position of the charging robot 100 under the vehicle 120. Optionally, a distance sensor 106 can be installed in the plugging arm 110, and therefore also be used to determine the position of the plugging arm 110 relative to the charging socket 130.

Optionally, a light can be installed on the charging socket 130 (e.g. an infrared light or a magnetic field) for far-field and near-field positioning of the charging robot 100. The charging robot 100 can have corresponding sensors 106 for sensing the light. When at least three surrounding sensors 106 are used on the charging robot 100, high-precision determination of position can be made possible by means of triangulation.

The near-field detection, in particular the approach of the plugging arm 110 to the charging socket 130 and the control and monitoring of the charging process can be carried out by means of a possible additional photosensor 106 on the charging robot 100, wherein the photosensor 106 is oriented in such a way that the charging socket 130 is in the field of vision of the photosensor 106.

Ultrasound sensors and/or magnetic-field-based surroundings sensors 106 are typically advantageous for a high level of robustness with respect to soiling.

In one example, a charging robot has the following surroundings sensors 106: distance sensors (ultrasound) which are configured to sense in the x-y plane (e.g. 4 items); at least one distance sensor (ultrasound) which is configured to sense in the z direction; a CCD array sensor (photosensor, image recognition); IR sensors or magnetic field sensor (e.g. 3 items); and/or angle sensors (drive wheels) (e.g. 2 items; one per driven wheel 104).

A further sensor system can be provided for the cable management/winding system (e.g. an angle sensor, a sensor for detecting the unwinding direction and/or the cable tension) and for the plug-in system.

As already explained, the charging robot 100 comprises a control unit 101. Exemplary tasks of the control unit 101 are: the actuation logic of the actuators, the evaluation and processing of the sensor data of the sensors 106, the surroundings detection and near field detection, the determination of position, the trajectory planning of the driving unit 108 and/or further functions e.g. for the interaction of the user of the charging robot 100. The first-mentioned functions result from the sensor system and actuator system used.

Further exemplary tasks of the control unit 101 are:
Control (e.g. start and stop) of the charging robot 100, e.g. by means of an app connection by means of an external electronic device (e.g. smartphone). The control can be triggered manually by a user, take place in a timed fashion and/or take place according to other criteria (e.g. price of electricity or smart grid technology).
Feedback of a status of the charging process (e.g. state of charge, anticipated charging duration, . . . ) by means of an app/internet application. In the case of an installed photosensor 106, image material and/or video material (e.g. underfloor inspection) can be transferred to a user.
Information from the underfloor area (image material, sensor system) of a vehicle 120 can be used in addition to the actual function of the charging robot 100 for status detection of a vehicle 120 or of a vehicle component, e.g. with the objective of detecting a need for maintenance.
Controlling of the charging process e.g. by means of virtual pushbutton keys which are projected onto the ground by the charging robot 100 and can be activated e.g. by foot. For this purpose, e.g. the distance sensor system or the photosensor can be used to detect the activation of a virtual pushbutton key.
Via a connection to the vehicle 120 to be charged, the sensor system (e.g. park distance control, reversing camera, surroundings camera, locating of radio key, etc.) of the vehicle 120 can also be used, e.g. for the determination of position and navigation of the charging robot 100. Furthermore, feedback of data to the vehicle 120 is made possible via this interface with the vehicle 100.
The charging robot 100 can provide e.g. a protection against pine martens as an additional function. As soon as an animal or moving object of the size of a pine marten is detected e.g. by means of a photosensor 106 of the charging robot 100, the charging robot 100 can attempt, e.g. by moving to the object, to drive it away. Optionally, the charging robot 100 can comprise additional units for driving and scaring away pine martens.

The charging robot 100 can be designed as a unit which moves on the ground. Alternatively, the charging robot 100 can be designed to move on a ceiling (e.g. on a garage ceiling), in order to avoid a charging cable 102 lying on the ground. The charging robot 100 can be mounted above a vehicle 120 by means of a suitable receptacle unit. This receptacle unit can have at least one lead rail, along which the charging robot 100 can be moved by means of its own drive or using an additional actuator system. In this way, an at least unidimensional working space in which the charging robot 100 can be positioned relative to the vehicle 120 is defined. A lead rail can be rotatably mounted in order to enlarge the working range and expand it to two dimensions.

The charging robot 100 can be positioned in such a way that the charging robot 100 can be let down to the ground in front of or to the side of a vehicle 120. The letting down can be carried out by means of a letting down device or can be integrated into the device for the cable management of the charging robot 100. When it has arrived on the ground, the charging robot 100 moves toward the charging socket 130 of the vehicle 100, as described in this document. After the charging process, the charging robot 100 can be pulled up again to its original position by means of the letting down device.

Alternatively, the device which is installed above the vehicle 120 can be used only for the cable guide, in order to avoid or minimize a charging cable 102 lying on the ground. The charging robot 100 can then move exclusively on the ground.

In this document, a charging device or a charging robot 100 is therefore described which in an efficient and reliable way permits automatic charging of traction batteries 123 in electrified vehicles (PHEV, BEV, etc.). The charging device 100 can be used particularly efficiently in locally limited areas (e.g. garages, underground garages, parking spaces, multistory carparks, etc.). The charging device 100 can be used here in conjunction with different types of vehicles 120.

The present invention is not restricted to the exemplary embodiments shown. In particular it is to be noted that the description and the figures are intended to illustrate only the principle of the proposed methods, devices and systems.

1.-18. (canceled)

19. A plug-in system for a wired charging process for charging an electrical energy store of an at least partially electrically operated device, comprising:
a charging socket which is arranged on the electrically operated device;
a charging device with a charging plug which is extendable toward the charging socket by a translatory movement;
wherein the charging socket comprises a cover in order to protect contact parts of the charging socket from environmental influences; and
wherein the charging plug is configured to generate one or more reclosable contact part openings in the cover by way of the translatory movement, through which openings contact parts of the charging plug are led within the scope of the translatory movement, in order to form, with the corresponding contact parts of the charging socket, respective pairs of galvanically conductive connections.

20. The plug-in system according to claim 19, wherein
the charging plug is configured to reclose the one or more contact part openings by way of an inverse translatory movement away from the charging socket, in order to protect the contact parts of the charging socket from the environmental influences.

21. The plug-in system according to claim 19, wherein
the charging plug has a guide bolt;
the cover has a bolt opening for receiving the guide bolt; and
the charging plug and the cover are embodied such that the one or more contact part openings are formed in reaction to translatory movement of the guide bolt within the bolt opening.

22. The plug-in system according to claim 21, wherein
the contact parts of the charging plug are arranged on the charging plug such that within the scope of the translatory movement the guide bolt firstly penetrates the bolt opening before the contact parts reach the cover.

23. The plug-in system according to claim 21, wherein
the cover comprises at least two cover disks, each with one or more holes; and
the guide bolt and the cover disks are embodied such that in reaction to the translatory movement of the guide bolt within the bolt opening, the cover disks are rotated with respect to one another so that holes in the cover disks are aligned one on top of the other so as to form the one or more contact part openings.

24. The plug-in system according to claim 23, wherein
the guide bolt has a slotted link which is designed to interact with a link block on at least one of the cover disks, in order to rotate the cover disks with respect to one another; or
at least one of the cover disks has a slotted link which is designed to interact with a link block on the guide bolt in order to rotate the cover disks with respect to one another.

25. The plug-in system according to claim 23, wherein
a seal is arranged between the two cover disks.

26. The plug-in system according to claim 23, wherein
the charging socket has a pressure element which is configured to apply a compressive force to the two cover disks in order to compress the cover disks, and
the charging socket is embodied such that the compressive force is reduced in reaction to the translatory movement of the guide bolt within the bolt opening.

27. The plug-in system according to claim 21, wherein
the guide bolt is designed to form a galvanically conductive connection to a contact element of the charging socket.

28. The plug-in system according to claim 19, wherein
the charging plug and the charging socket are embodied such that the contact parts are locked to one another within the scope of the translatory movement.

29. The plug-in system according to claim 19, wherein
a contact part of the charging plug and a corresponding contact part of the charging socket have complementary profiles by which:
a securing force is produced when the contact parts are plugged one into the other; and/or
a contact surface between the contact parts is enlarged in comparison with a planar profile.

30. The plug-in system according to claim 19, wherein
the charging device comprises an electrically operated actuator which is configured to bring about the translatory movement of the charging plug.

31. The plug-in system according to claim 19, wherein the charging device comprises:
a mobile housing on or in which the charging plug is arranged; and
a winding roller which is configured to wind-on a charging cable by which the charging plug is connected to a power supply.

32. The plug-in system according to claim 31, wherein
the winding roller is embodied, in the event of a movement of the charging device, to unwind or wind-on the charging cable such that the charging cable is tensioned between the power supply and the charging device.

33. The plug-in system according to claim 31, wherein
the winding roller is arranged on an outer wall of the housing so as to be rotatable about a vertical axis of the charging device.

34. The plug-in system according to claim 19, wherein
the at least partially electrically operated device is a road vehicle;
the charging socket is arranged on an underfloor of the road vehicle; and
the charging device is designed to plug the charging plug into the charging socket along a vertically extending translatory movement.

35. A charging socket for a plug-in system, in which
the plug-in system permits a wired charging process for charging an electrical energy store of an at least partially electrically operated device,
the charging socket is designed to be arranged on the electrically operated device, and
the plug-in system comprises a charging device with a charging plug which is extendable toward the charging socket by a translatory movement,
wherein the charging socket comprises:
contact parts which are configured to transmit electrical energy for charging the electrical energy store;
a cover in order to protect the contact parts of the charging socket from environmental influences; and
wherein the charging socket is configured to open, in reaction to the translatory movement of the charging device, one or more reclosable contact part openings in the cover through which openings contact parts of the charging plug are led within the scope of the translatory movement, in order to form, with the corresponding contact parts of the charging socket, respective pairs of galvanically conducive connections.

36. A charging device for a plug-in system, in which
the plug-in system permits a wired charging process for charging an electrical energy store of an at least partially electrically operated device,
wherein the charging device comprises:
a charging plug which, by way of a translatory movement, is extendable toward a charging socket which is arranged on the at least partially electrically operated device;
the charging socket comprises a cover in order to protect contact parts of the charging socket from environmental influences; and
the charging plug is configured to generate one or more reclosable contact part openings in the cover by way of the translatory movement, through which openings contact parts of the charging plug are led within the scope of the translatory movement, in order to form, with the corresponding contact parts of the charging socket, respective pairs of galvanically conductive connections.
